(19) United States
(12) Patent Application Publication
(10) Pub. No.: US 2025/0052271 A1
(43) Pub. Date: Feb. 13, 2025

(54) SCREW STRUCTURE

(71) Applicant: INTEGRAL BUILDING PRODUCTS INCORPORATION, TAINAN CITY (TW)

(72) Inventor: LI-CHING HSIAO, TAINAN CITY (TW)

(21) Appl. No.: 18/447,379

(22) Filed: Aug. 10, 2023

(51) Int. Cl. F16B 25/00

(52) U.S. Cl. CPC F16B 25/0042

(57) ABSTRACT

The present invention relates to a screw structure, including a head part, a rod part, a first thread and a second thread. The head part is arranged at one end of the rod part. The other end of the rod part is opposite to the head part to form a tapered tap-lock screw-in end. The first thread is arranged on the surface of the rod part with a clockwise spiral ring and extends to the tap-lock screw-in end. The second thread is arranged on the surface of the tap-lock screw-in end with a counterclockwise spiral ring. The crest height of the second thread is lower than 50% of the crest height of the first thread, and several teeth are formed on the second thread. Accordingly, through the setting of the second thread, the screw has multiple functions such as crushing and chip removal.

### BACKGROUND OF THE PRESENT INVENTION

### Field of Invention

The present invention relates to a screw structure, in particular to a screw that is used for wood materials and has excellent crushing and chip removal functions.

### Description of Related Arts

It is noted that the wood material itself has a fiber texture and is not rigid, so when locking the screw, the screw used must have the function of cutting the fiber to drill deep into the wood material.

The conventional screw includes a rod body, a screw head, a tip, and a thread. The screw head is arranged at one end of the rod body, the tip is arranged at the other end of the rod body, and the thread is arranged on the rod body in a helical ring from the tip to the screw head. When the screw is drilled into the wood material, the screw-in end can be used to drive into the wood material, and the thread on the rod body cuts off the wood fiber and locks in continuously to complete the locking.

However, when the conventional screw is locked into the wood material, the threaded section on the screw-in end is used to twist and break the wood fiber to help the screw advance. The thread on the screw-in end cuts out a matching female thread during the process of screw-locking the wood material, but relatively produces resistance and hinders the screw from screwing in, making it difficult for the screw to advance and screw in. In addition, the chips generated when the thread is drilling and tapping wood materials are not discharged and remain accumulated in the wood materials. These residual accumulated chips will squeeze the wood material after being screwed into the screw, causing pressure on the interior of the wood material, affecting the structural strength of the wood material, and even causing the wood material to crack and damage.

### SUMMARY OF THE PRESENT INVENTION

In view of the defects caused by the above-mentioned conventional screws locked into wood materials, the present invention provides a screw that has the functions of crushing and chip removal during screwing into the workpiece to ensure that the structural strength of the workpiece is not damaged, and this is the purpose of the present invention.

Above-mentioned object is realized by following technology:

A screw structure includes a head part, a rod part, a first thread, and a second thread, wherein the head part is arranged at one end of the rod part, wherein the rod part forms a tapered tap-lock screw-in end at the other end opposite to the head part, wherein in the position of the rod part adjacent to the head part, the first thread is arranged on the surface of the rod in a clockwise spiral ring and extends to the tap-lock screw-in end, wherein the second thread is arranged on the surface of the tap-lock screw-in end with a counterclockwise spiral ring, and the second thread includes several teeth arranged thereon.

The screw structure as mentioned above, wherein the crest height of the second thread is less than 50% of the crest height of the first thread, but close to half the crest height of the first thread.

The screw structure as mentioned above, wherein the crest height of the second thread is less than or equal to the crest height of the first thread.

The screw structure as mentioned above, wherein the teeth are arranged at equal intervals.

The screw structure as mentioned above, wherein the teeth are in the shape of a quadrangular pyramid.

The advantages and effects provided by the present invention include the following:

The screw structure of the present invention is a second thread provided with a counterclockwise spiral ring at the tap-lock screw-in end of the rod part of the screw, when the screw is screwed into the workpiece, a chip removal effect is produced. At the same time, by using the teeth structure formed on the second thread, when the screw is screwed into the workpiece, the function of grinding the workpiece is produced, so that the screw can be drilled into the workpiece more easily.

### BRIEF DESCRIPTION OF THE DRAWINGS

FIG. 1 illustrates the perspective view of the screw structure of the present invention.

FIG. 2 illustrates the enlarged perspective view of the tap-lock screw-in end of the screw of the present invention.

FIG. 3 illustrates the perspective view when the screw of the present invention is screwed into the workpiece.

### DETAILED DESCRIPTION OF THE PREFERRED EMBODIMENT

In order to have a more complete and clear disclosure of the technical content used in the present invention, the purpose of the invention and the effect achieved, the present invention is described in detail below, referring to the disclosed drawings and drawing numbers:

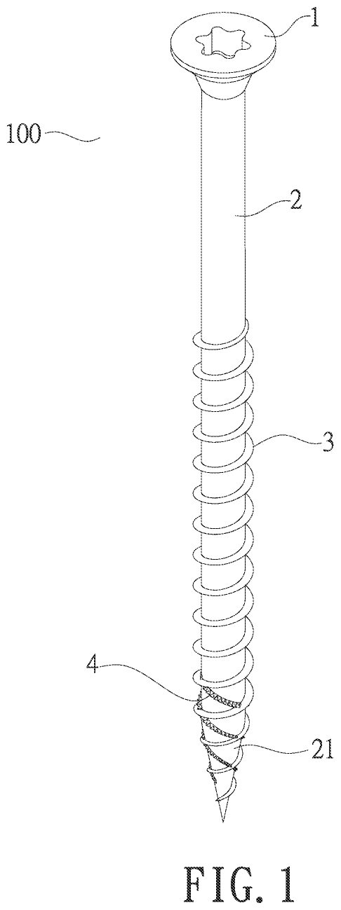

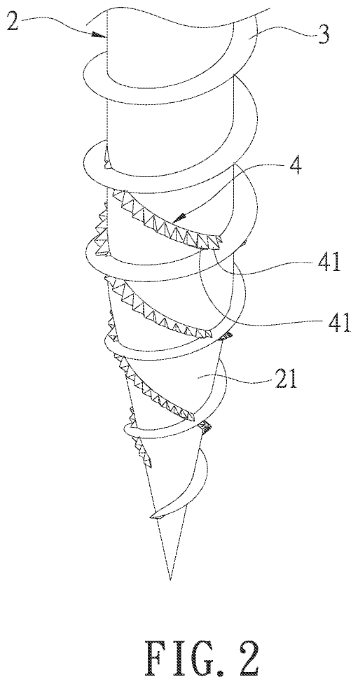

Referring to FIGS. 1 and 2, FIG. 1 is a perspective view illustrating the screw structure of the present invention, and FIG. 2 is an enlarged perspective view illustrating the tap-lock screw-in end of the screw of the present invention.

The screw 100 of the present invention includes a head part 1, a rod part 2, a first thread 3 and a second thread 4, wherein:

the rod part 2 has two ends opposite to each other, the head part 1 is arranged at one end of the rod part 2, and a tapered tap-lock screw-in end 21 is formed at the other end of the rod part 2, wherein the first thread 3 is arranged on the surface of the rod part 2 in a clockwise spiral ring, and the first thread 3 extends from the position of the rod part 2 adjacent to the head part 1 to the tap-lock screw-in end 21, wherein the second thread 4 is arranged on the surface of the tap-lock screw-in end 21 in a counterclockwise spiral ring, and the second thread 4 includes several teeth 41 arranged thereon.

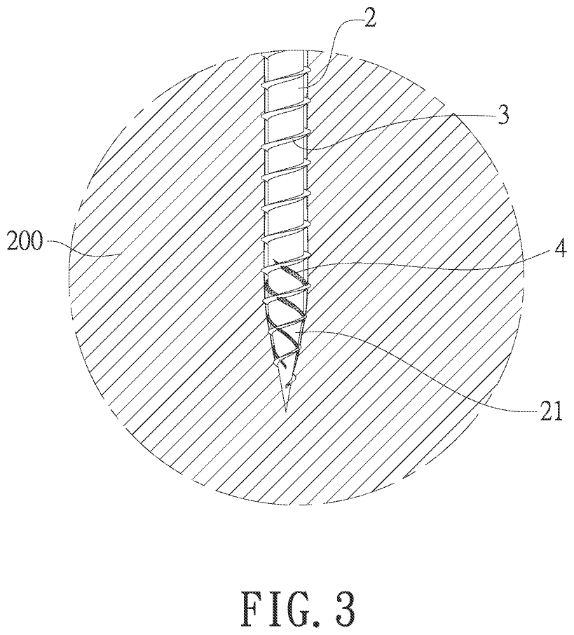

Thus, when the screw 100 wants to be screwed into the workpiece 200 (referring to FIGS. 2 and 3), the second thread 4 with a counterclockwise spiral ring is arranged at the tap-lock screw-in end 21 of the rod part 2, producing an excellent chip removal effect. At the same time, the teeth 41 formed on the second thread 4 are further used to produce the function of crushing the workpiece 200 when the screw 100 is screwed into the workpiece 200, so that the screw 100 can be drilled into the workpiece 200 more easily.

According to a preferred embodiment, the crest height of the second thread 4 of the screw 100 of the present invention is less than 50% of the crest height of the first thread 3, but close to half the crest height of the first thread 3. That is, the pitch of the second thread 4 is no more than half of the pitch of the first thread 3.

According to a preferred embodiment, the crest height of the second thread 4 is less than or equal to the crest height of the first thread 3.

According to a preferred embodiment, the teeth 41 of the screw 100 of the present invention on the second thread 4 are arranged at equal distances from each other. Moreover, preferably, the teeth 41 are in the shape of a quadrangular pyramid.

What is claimed is:

1. A screw structure, comprising: a head part, a rod part, a first thread, and a second thread; wherein the head part is arranged at one end of the rod part, wherein the rod part forms a tapered tap-lock screw-in end at the other end opposite to the head part, wherein in the position of the rod part adjacent to the head part, the first thread is arranged on the surface of the rod part in a clockwise spiral ring and extends to the tap-lock screw-in end, wherein the second thread is arranged on the surface of the tap-lock screw-in end with a counterclockwise spiral ring, and the second thread includes several teeth arranged thereon.

2. The screw structure as claimed in claim 1, wherein the crest height of the second thread is less than 50% of the crest height of the first thread, but close to half the crest height of the first thread.

3. The screw structure as claimed in claim 2, wherein the teeth are arranged at equal intervals.

4. The screw structure as claimed in claim 3, wherein the teeth are in the shape of a quadrangular pyramid.

5. The screw structure as claimed in claim 1, wherein the teeth are arranged at equal intervals.

6. The screw structure as claimed in claim 5, wherein the teeth are in the shape of a quadrangular pyramid.
